(19) United States
(12) Patent Application Publication
(10) Pub. No.: US 2025/0111271 A1
(43) Pub. Date: Apr. 3, 2025

(54) TELEMETRY DATA PROCESSING AND REPRESENTATIONS FOR FOUNDATION MODELS

(71) Applicant: International Business Machines Corporation, Armonk, NY (US)

(72) Inventors: Taesung Lee, Ridgefield, CT (US); XIAOKUI SHU, Ossining, NY (US); Matan Levi, Tel Aviv (IL); Kevin Eykholt, Cambridge, MA (US); Anton Puzanov, Mitzpe Ramon (IL); Youngja Park, Princeton, NY (US); Ian Michael Molloy, Westchester, NY (US); Yair Allouche, Dvira (IL)

(21) Appl. No.: 18/479,911

(22) Filed: Oct. 3, 2023

(51) Int. Cl. G06N 20/00

(52) U.S. Cl. CPC G06N 20/00

(57) ABSTRACT

Computer-implemented methods for telemetry data processing and representations for foundation models are provided. Aspects include generating a graph data structure based on processing telemetry data associated with at least one computer system, where the graph data structure is representative of a set of events and a set of entities associated with the at least one computer system. Aspects include generating a textual representation of behavioral information associated with at least one entity of the set of entities and at least one event of the set of events, based on one or more subgraphs included in the graph data structure. Aspects include obtaining an analysis result associated with the at least one computer system based on processing the textual representation by one or more models.

### BACKGROUND

The present disclosure generally relates to telemetry data processing, and more specifically, to converting telemetry data into a textual representation of system behaviors for machine learning models such as, for example, foundation models.

Telemetry is a tool supportive of recording system activities. Telemetry data provides value for monitoring applications such as, for example, cybersecurity applications. Improved techniques for distilling information and knowledge from the telemetry data are desired.

### SUMMARY

Embodiments of the present disclosure are directed to computer-implemented methods for telemetry data processing and representations for machine learning models. According to an aspect, a computer-implemented method includes generating a graph data structure based on processing telemetry data associated with at least one computer system, where the graph data structure is representative of a set of events and a set of entities associated with the at least one computer system. The method also includes generating a textual representation of behavioral information associated with at least one entity of the set of entities and at least one event of the set of events, based on one or more subgraphs included in the graph data structure. The method also includes obtaining an analysis result associated with the at least one computer system based on processing the textual representation by one or more models, where the one or more models include at least one of a machine learning model, a statistical model, and a foundation model.

Embodiments also include a computing system having a memory having computer readable instructions and one or more processors for executing the computer readable instructions. The computer readable instructions controlling the one or more processors to perform operations that include generating a graph data structure based on processing telemetry data associated with at least one computer system, where the graph data structure is representative of a set of events and a set of entities associated with the at least one computer system. The operations also include generating a textual representation of behavioral information associated with at least one entity of the set of entities and at least one event of the set of events, based on one or more subgraphs included in the graph data structure. The operations also include obtaining an analysis result associated with the at least one computer system based on processing the textual representation by one or more models, where the one or more models include at least one of a machine learning model, a statistical model, and a foundation model.

Embodiments also include a computer program product having a computer readable storage medium having program instructions embodied therewith. The program instructions executable by a processor to cause the processor to perform operations that include generating a graph data structure based on processing telemetry data associated with at least one computer system, where the graph data structure is representative of a set of events and a set of entities associated with the at least one computer system. The operations also include generating a textual representation of behavioral information associated with at least one entity of the set of entities and at least one event of the set of events, based on one or more subgraphs included in the graph data structure. The operations also include obtaining an analysis result associated with the at least one computer system based on processing the textual representation by one or more models, where the one or more models include at least one of a machine learning model, a statistical model, and a foundation model.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure.

FIG. 2 depicts a block diagram of an example computer system for use in conjunction with one or more embodiments of the present disclosure.

FIG. 3 depicts a diagram of a preprocessing pipeline in accordance with one or more embodiments of the present disclosure.

FIG. 4 depicts a graph of an example event in accordance with one or more embodiments of the present disclosure.

FIG. 5 depicts an example graph data structure in accordance with one or more embodiments of the present disclosure.

FIG. 6 depicts an example subgraph data structure in accordance with one or more embodiments of the present disclosure.

FIG. 7 depicts an example flow diagram of preprocessing for large language models.

FIG. 8 depicts a flowchart of a method in accordance with one or more embodiments of the present disclosure.

### DETAILED DESCRIPTION

Telemetry is a tool supportive of recording system activities. Telemetry data provides value for monitoring applications such as, for example, cybersecurity applications. In some cases, distilling information and knowledge from the telemetry data for monitoring applications may be challenging due to the amount of telemetry data.

Some aspects of machine learning models (e.g., foundation models, statistical models, or the like) support a feasible approach to understand and perform tasks from telemetry data for cases in which the amount of labeled data included in the telemetry data is relatively minimal (e.g., less than a threshold amount of labeled data). For example, some machine learning models can be pre-trained with unlabeled data and fine-tuned into downstream models, with a relatively small amount of labeled data. Machine learning models can be used for applications without such labeled data.

Raw telemetry data or log files mixed from different monitored system entities can be subject to noise, for example, as the number of events (and system entities associated with the events) included in the telemetry data can be very large (e.g., in the thousands, tens of thousands, and the like). In some cases, telemetry data does not have a clear boundary between entities. Further, for example, highly related events might be located in different places in the raw telemetry data, which will add complexity and prevent a machine learning model from effectively and successfully learning the relationship between the events when processing the telemetry data. Thus, when attempting to process raw telemetry data or log files, some machine learning model architectures (e.g., foundation model architectures, statistical model architectures, or the like) and large language model (LLM) technologies are not sufficient to understand the relation between different lines of logs from a continuous stream of seemingly irrelevant logs included in the telemetry data.

According to one or more embodiments of the present disclosure, systems, methods, and computer program products are provided which support processing raw telemetry data, before feeding the data to the machine learning models, such that the processed data will align with the capabilities of machine learning models (e.g., foundation models such as, for example, LLMs) to which the processed data will be provided. The techniques described herein take advantage of existing LLM architectures (e.g., transformers) and support using the LLM architectures “out of the box” for monitoring applications (e.g., security related telemetry).

According to one or more embodiments of the present disclosure, a method is described for using security related telemetry as a text modality input to the machine learning model and considers a preprocessing pipeline described herein to prepare the textual input from raw telemetry data. Raw telemetry data may be a collection of events generated by processes (e.g., of a user, interacting with processes, files, and network endpoints), in some cases ordered by event time. The raw telemetry data may include a river of many intertwined streams of events in a single giant document (e.g., multiple gigabytes in size) and, though the raw telemetry data may include events and temporal information related to the events, the raw telemetry data is absent relational data between the events. The techniques described herein support a tailored preprocessing capable of generating, from the raw telemetry data, a sentence describing a system behavior, in which the sentence is less than or equal to a threshold sentence length supported by a model (e.g., a machine learning model, a foundation model, a statistical model, an LLM, a non-foundation model FM machine learning model, a deep learning model, or the like) to which the sentence is to be provided.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as telemetry data processing and textual data analysis by block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 135), and network module 115. Remote server 104 includes remote database 132. Public Cloud 105 includes gateway 130, Cloud orchestration module 131, host physical machine set 142, virtual machine set 143, and container set 144.

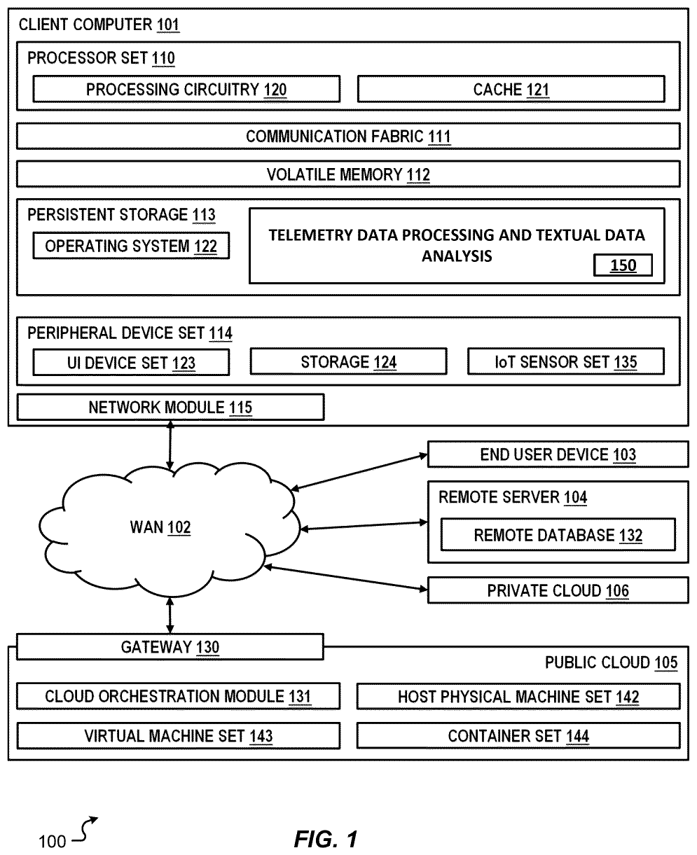

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

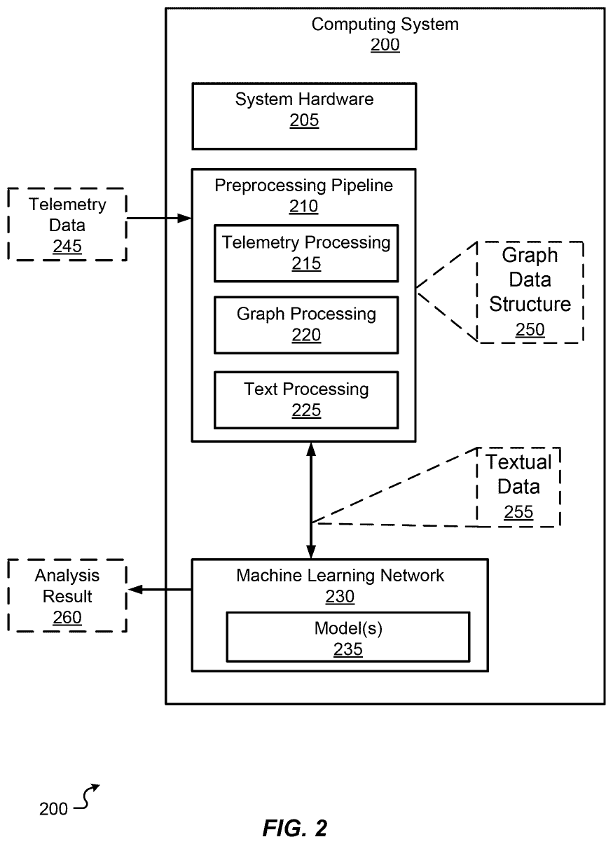

FIG. 2 depicts a block diagram of an example computer system 200 that supports telemetry data processing and textual data analysis in accordance with one or more embodiments of the present disclosure. All or a portion of the computer system 200 shown in FIG. 2 can be implemented, for example, by all or a subset of the computing environment 100 of FIG. 1. In one or more embodiments, the computer system 200 is embodied in a computer 101 as the one shown in FIG. 1.

The computer system 200 includes system hardware 205. The system hardware 205 includes the central processing units (CPUs), graphical processing units (GPUs), memory, and the like that are part of the computing system. The system hardware 205 executes computer code stored at a memory (e.g., volatile memory 112, persistent storage 113, storage 124, and the like described with reference to FIG. 1) of the computer system 200.

The computer system 200 includes a machine learning network 230. The computer system 200 may utilize data stored in a corresponding memory (e.g., memory of a computer 101, memory of a EUD 103, memory at a remote server 104, and the like) as a machine learning network 230. Machine learning network 230 may include a machine learning architecture. In some other aspects, the machine learning network 230 may be or include any suitable machine learning network such as, for example, a deep learning network, a convolutional neural network, or the like.

The machine learning network 230 may include a model(s) 235 (e.g., machine learning model, a statistical model, a foundation model, a LLM, a machine learning model different from a foundation model, a deep learning model, and the like) which may be trained and/or updated based on data (e.g., training data) provided or accessed by the computer system 200. The model(s) 235 may be built and updated by the computer system 200 based on the training data (also referred to herein as training data and feedback). In some aspects, the model(s) 235 may be built and updated by the computer system 200 based on data generated by and/or operations performed by the 200. In one or more embodiments, the model(s) 235 may include foundation models, LLMs, or other general machine learning models (e.g., non-foundation model (FM) machine learning models). It is to be understood that the example embodiments described herein can be implemented in association with any suitable model(s) described herein (e.g., a machine learning model, a deep learning model, a statistical model, a foundation model, a LLM, a non-FM machine learning model, and the like) or combination of the models.

The preprocessing pipeline 210 includes telemetry processing 215, graph processing 220, and text processing 225. All or a portion of the preprocessing pipeline 210 can be implemented, for example, by all or a subset of the computing environment 100 of FIG. 1 or the computer system 200 of FIG. 2.

According to one or more embodiments of the present disclosure, the computer system 200 may generate a graph data structure 250 based on processing telemetry data 245 associated with at least one computer system. In some aspects, the graph data structure 250 is representative of events and entities associated with the at least one computer system. The computer system 200 may generate textual data 255 representing behavioral information associated with at least one entity of the entities and at least one event of the events, based on one or more subgraphs included in the graph data structure 250. The textual data 255 may also be referred to herein as a textual representation of the behavioral information. The computer system 200 may obtain an analysis result 260 associated with the at least one computer system and/or network system (e.g., behavior of at least one computer system and/or at least one network system) based on the processing of the textual representation 255 by a model 235 (e.g., machine learning model, statistical model, foundation model, an LLM, and the like).

It is to be understood that the telemetry data described herein may be associated with a computer system, a network system, or both. For example, the log data associated with the graph data structure 250 may include network events/entities. In one or more embodiments, portions (e.g., subgraphs) of the graph data structure 250 may be associated with a network system, and other portions (e.g., other subgraphs) of the graph data structure 250 may be associated with a computer system but not a network system. In an example, in one or more embodiments, one or more subgraphs may be absent a network system entity (e.g., IP address). In an example, a subgraph around a Linux command may touch file and user entities, without touching a network system.

As described herein, the example systems, methods, and computer program products described herein support converting telemetry data 245 into sentences representing system behaviors for a model 235 by constructing a graph data structure 250, sampling subgraphs, and textualizing the subgraphs. The techniques include sampling subgraphs that include key information for behaviors of system entities by identifying the focal entity and its surroundings, including the process ancestry and generated events. The techniques include textualizing system behaviors represented by the graph data structure 250 (or subgraphs) to a sequence of tokens using template-based natural language generation or context-free grammar. The techniques described herein include truncating long textualized sequences while maintaining key behavioral information by prioritizing certain types of edges and entities including process ancestry. The techniques include augmenting telemetry data with external domain knowledge that can be easier for large language models to understand.

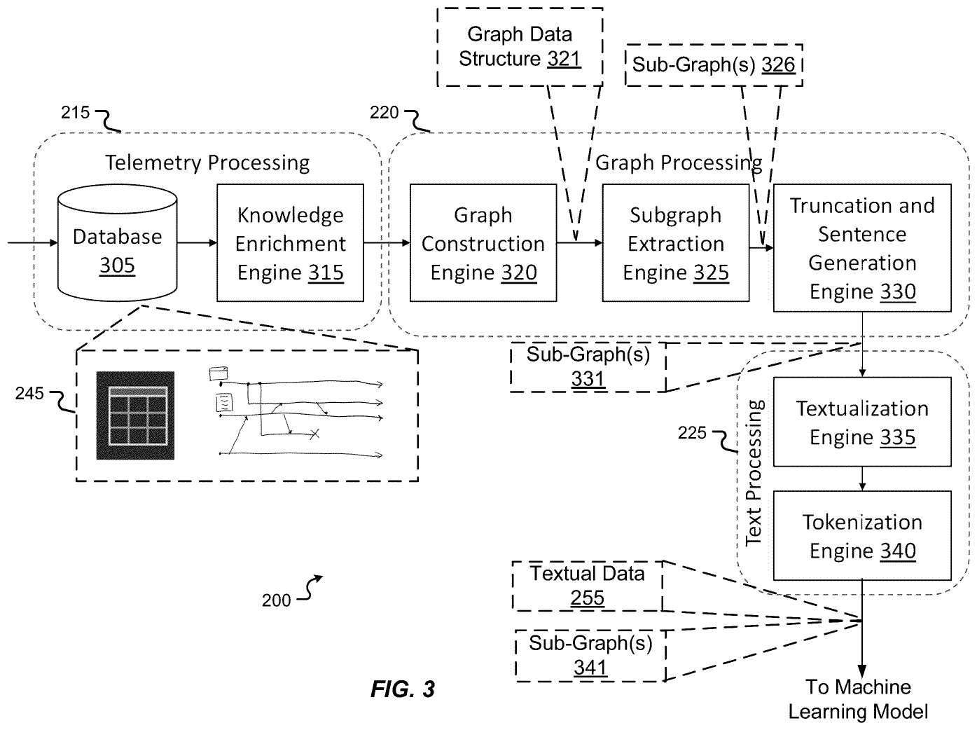

FIG. 3 illustrates an example diagram of the preprocessing pipeline 210 of FIG. 2. According to one or more embodiments of the present disclosure, telemetry processing 215 may be implemented by a knowledge enrichment engine 315. Graph processing 220 may be implemented by a graph construction engine 320, a subgraph extraction engine 325, and a truncation and sentence generation engine 330. Text processing 225 may be implemented by a textualization engine 335 and a tokenization engine 340. Each of the engines may be implemented by all or a subset of the computing environment 100 of FIG. 1 or the computer system 200 of FIG. 2.

In an example implementation, the preprocessing pipeline 210 may access telemetry data 245 from a database 305. The telemetry data 245 may include data and information related to the functioning, performance, and security of a network infrastructure including one or more computer systems and/or network systems.

In some cases, the log data is not in a natural language. In some aspects, the telemetry data 245 may be log data in table form or in timeline form, in which the X-axis represents time, and the Y-axis is associated with events included in the telemetry data 245. For example, existing foundation models or LLMs may be incapable of understanding the telemetry data 245 in raw form (e.g., log sentences), and accordingly, be unable to effectively assess system behavior, system anomalies, and the like from telemetry data 245. In one or more embodiments, the preprocessing pipeline 210 provides textual data 255 in a format such that a model 235 may identify control flow (e.g., causal relations A on B) and data flow (also referred to herein as “information flow”) associated with a network system and provide a corresponding analysis result 260.

According to one or more embodiments of the present disclosure, the preprocessing pipeline 210 supports features of textualization, domain knowledge enrichment, graph construction, subgraph sampling (also referred to herein as “subgraph extraction”), truncation and sentence extraction (also referred to herein as “truncation and sentence generation”), and tokenization in association with processing the telemetry data 245.

Textualization engine 335 is capable of textualizing each event (log entry) from telemetry data 245 or a set of relevant events that can be represented by a graph data structure 250. Knowledge enrichment engine 315 is capable of enriching events with domain knowledge transformations and data. Graph construction engine 320 is capable of building a graph data structure 321 of events (also referred to herein as “edges”) and monitored entities (also referred to herein as “nodes” or “objects” or “processes”) to find the concise context of a behavior. The edges may represent system calls made by an entity (process) represented as a node in the graph data structure 321.

Examples of the monitored entities include processes, files, user, and hosts, and the like, and are not limited thereto. Subgraph extraction engine 325 is capable of extracting subgraphs (also referred to herein as “subgraph data structures”) of relevant information from the graph data structure 321.

Truncation and sentence generation engine 330 is capable of extracting textual input (sentences) using one or more subgraphs 326 of the graph data structure 321. In one or more embodiments, truncation and sentence generation engine 330 extracts the textual input (sentences) in view of a threshold input length supported by a model 235 to which the textual input is to be provided. For example, the textual input provided by the truncation and sentence generation engine 330 is less than or equal to a threshold input length supported by the model 235. Tokenization engine 340 is capable of tokenization operations that convert words into tokens and corresponding token identifiers (IDs) that the model 235 can consume. In an example, tokenization engine 340 converts words/text provided by truncation and sentence generation engine 330 and/or textualization engine 335 into tokens and IDs which correspond to the tokens. Additional example aspects of the preprocessing pipeline 210 (e.g., knowledge enrichment engine 315 through tokenization engine 340) are further described with reference to the following figures.

It is to be understood that the example processing order illustrated in FIG. 3 is an example, and aspects of the preprocessing pipeline 210 are not limited thereto. For example, in accordance with one or more embodiments of the present disclosure, the features provided by the engines (e.g., knowledge enrichment engine 315 through tokenization engine 340) described with reference to FIG. 3 can be applied in any suitable order supportive of the techniques described herein.

For example, knowledge enrichment may be performed any time before textualization. Textualization can be applied at any stage. Alternatively or additionally, instead of using textualization as an independent step, subgraph extraction engine 325, truncation and sentence generation engine 330, textualization engine 335, and tokenization engine 340 are capable of interacting with each other to check the length of a tokenized sentence (e.g., tokenized textual data 255) output by tokenization engine 340.

In one or more embodiments, the techniques described herein support using the processing described with reference to preprocessing pipeline 210 for pre-training and downstream tasks. For prediction using a downstream model, the textual representation 255 to be provided to the model can be optionally appended by the entity of interest which may use a certain expression. The preprocessing pipeline 210 supports any suitable ordering and configuration of the engines to generate an output for a certain purpose. The application scenario can determine types of events and attributes to be processed by the preprocessing pipeline 210. For example, the preprocessing pipeline 210 is configurable to process network-related events, process file-related events, or process all event types.

Example detailed aspects of the preprocessing pipeline 210 (e.g., knowledge enrichment engine 315 through tokenization engine 340) are further described herein.

### Textualization Engine 335—Event, Entity or Subgraph Textualization

In some aspects, each event or information about an entity from telemetry data 245 is a text string or a record with attribute names and values. The text string (or record) may include the event type and the actor (entity) name. In some cases, the data (e.g., representing each event or information about an entity) can be viewed as a dictionary (a set of key-value pairs): {attribute name: attribute value}.

The textualization engine 335 is capable of textualizing the event by serializing the dictionary with special tokens between serialized key-value pairs (e.g., [attribute name 1]=[attribute value 1]<EOA> [attribute name 2]=[attribute value 2]<EOA>). Additionally, or alternatively, the textualization engine 335 is capable of textualizing the event in a natural language format such as, for example, “Process with parent base file name apt-get and image file name http was created. Event platform is local interconnect network (LIN) and command line/usr/lib/apt/methods/http,” “Communication with remote IP from country United Kingdom and ASN Canonical Group Limited in flow direction outbound using protocol UDP and application http,” and “Communication with remote IP local host in flow direction outbound using protocol UDP and application Unknown.”

The techniques described herein support generalizing the telemetry data 245 (or textualized data output by textualization engine 335, for cases in which textualization is previously applied) to a subgraph of entities and associated events. One example implementation can include concatenation of individual textualized events or entities within the subgraph, with or without a separator expression such as <EOE>. The order in the concatenation can be temporal. Additionally, or alternatively, the order can be topological (a creation event has to happen before adding other information about the node). In another embodiment, the ancestry of a process entity can be placed together (e.g., at the beginning of the sentence).

### Knowledge Enrichment Engine 315—Domain Knowledge Enrichment

Knowledge enrichment engine 315 is capable of enriching telemetry events with domain knowledge data or domain specific processing. In some aspects, domain knowledge may include network topology, architecture, internal knowledge about communication and stations of a network system, and the like, and is not limited thereto.

In accordance with one or more embodiments of the present disclosure, the telemetry events may include network events, and the knowledge enrichment engine 315 is capable of enriching various fields associated with the network events. Knowledge enrichment engine 315 is capable of replacing a portion of telemetry data 245 with corresponding domain knowledge, and in some other examples, appending the corresponding domain knowledge to the portion of the telemetry data 245. Non-limiting examples of enrichment supported by the knowledge enrichment engine 315 are described herein.

In an example, knowledge enrichment engine 315 is capable of enriching external IP addresses by Autonomous System Number (ASN) and organization, Country, City, and the like. In another example, knowledge enrichment engine 315 is providing domain knowledge such that local IP addresses can be identified by the organization network management system. Knowledge enrichment engine 315 is capable of flagging a specific machine using a given local IP address and providing an indication to the model 235 that the IP address is an external IP address used by a specific machine at a given time.

In an example, since IP addresses can be dynamic, knowledge enrichment engine 315 is capable of replacing the IP address with corresponding domain knowledge, or alternatively, using the domain knowledge alongside the IP address. For example, knowledge enrichment engine 315 may replace a local IP address with other information (e.g., asset name, user ID). In another example, knowledge enrichment engine 315 may replace an external IP address with a domain name.

In another example, for a given port, knowledge enrichment engine 315 may enrich the port number with an indication of an application used by the given port. For example, for cases in which the knowledge enrichment engine 315 determines from the telemetry data 245 that an SSH application is typically used (e.g., based on quantity of uses) by a destination port 22, the knowledge enrichment engine 315 may replace “destination port 22” with “SSH,” “SSH port,” or the like. In another example, for cases in which the knowledge enrichment engine 315 determines from the telemetry data 245 that an HTTPs application is typically used (e.g., based on quantity of uses) by a port 443, the knowledge enrichment engine 315 may replace “port 443” with “HTTPs.”

Though the above examples demonstrate how events can be enriched by domain knowledge with respect to network events, the domain knowledge is not limited thereto. Other example domain specific processing supported by embodiments of the present disclosure includes transforming attribute values based on attribute value type e.g., filename segmentation, file path normalization, file permission mask decomposition, and the like).

### Graph Construction—Graph Construction Engine 320

In some cases, a single event included in the telemetry data 245 may be irrelevant on its own for identifying behaviors of interest of a network system, and the techniques described herein support generating a broader view for identifying any appropriate behaviors of interest. For example, since telemetry records a large number of events, the manner in which the events are grouped together or ordered in the telemetry data 245 may impact the accuracy of a model 235 (e.g., machine learning model, statistical model, foundation model, an LLM, a non-FM machine learning model, or the like) with respect to analyzing the telemetry data 245, and the natural temporal order of the events may be insufficient for providing contextual information related to the events. That is, one process included in the telemetry data 245 may have generated two relevant events, but thousands of other unrelated events included in the telemetry data 245 may have been produced by other processes on the same system in between the two relevant events. On the other hand, if two different processes access the same file, they might be related. According to one or more embodiments of the present disclosure, instead of using a temporal order associated with events included in the telemetry data 245, or instead of focusing solely on all events from one process, the techniques described herein build (using graph construction engine 320) a graph data structure 321 and use one or more subgraphs 326 (as extracted by subgraph extraction engine 325) to contextualize a behavior, capturing both potential data flow and control flow.

In some cases, in regard to telemetry data 245, each event from telemetry is a relation. The relation may be binary with one entity acting on another entity (e.g., a process writes to a file), but can be unary (e.g., entity attributes), ternary (e.g., a process renames a file into another file), and the like. Based on an analysis of the telemetry data 245, graph construction engine 320 is capable of recognizing and building a graph data structure 321 of entities and relations between the entities.

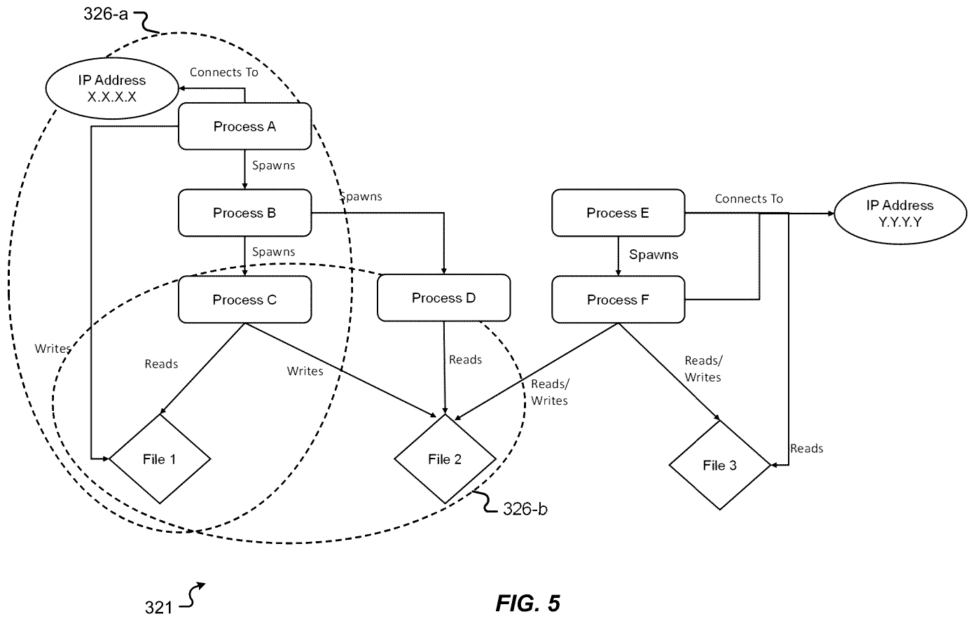

In addition to the graph construction engine 320 populating edges corresponding to events (e.g., read, write, spawn, and the like) included in the telemetry data 245, the graph construction engine 320 may provide, in the graph data structure 321, additional information in association with each event. For example, the graph construction engine 320 is capable of providing additional information about the entities (nodes in the graph data structure 321) through object creation events. In an example, the additional information may include object names (e.g., process names, file names, network IP/port names, usernames, and the like). An example of the graph data structure 321 is later described with reference to FIG. 5.

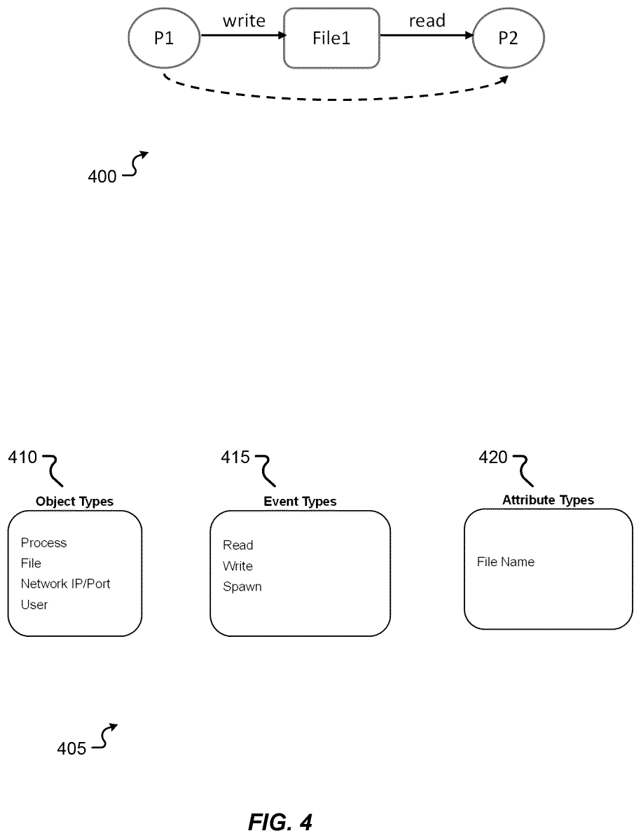

FIG. 4 depicts a graph 400 of an example event, included in telemetry data 245, in which a process P1 writes to a file (File1) and a process P2 reads the same file. Some other techniques which implement process-only sentence representation can miss indirect relationships through other entities such as files (e.g., between process P1 and process P2).

In contrast, the techniques described herein include implementing object-centric sentence representation, which supports capturing context and indirect relations. Diagram 405 illustrates examples of object types 410 (also referred to herein as node types) (e.g., process, file, network IP/port, user), event types 415 (also referred to herein as edge types) (e.g., read, write, spawn), and attribute types 420 (e.g., file name) obtained from telemetry data 245 using the techniques described herein in accordance with embodiments of the present disclosure.

### Subgraph Extraction Engine 325—Subgraph Sampling

FIG. 5 illustrates an example 500 of a graph data structure 321 (also referred to herein as a “graph data structure”) generated by graph construction engine 320 from telemetry data 245 in accordance with one or more embodiments of the present disclosure. FIG. 5 further illustrates example subgraphs 326 (e.g., subgraph 326-a, subgraph 326-b) extracted from graph data structure 321 by subgraph extraction engine 325 in accordance with one or more embodiments of the present disclosure.

In some cases, graph data structure 321 as output by graph construction engine 320 encapsulates many pieces of connected information and cannot be directly input to and processed by models 235 due to the size of graph data structure 321. Subgraph extraction engine 325 supports features for projecting parts of the graph data structure 321 to provide to models 235 (e.g., projecting subgraphs 326 to provide to model 235). The preprocessing pipeline 210 supports creating an input for the machine learning network 230 by further concatenating (e.g., at truncation and sentence generation engine 330) the information included in an extracted subgraph 326 (or subgraphs 326) according to a target input length supported by a model 235. In one or more embodiments, the input length may be set according to a certain parameter (e.g., 512, 2048).

In some cases, some events in graph data structure 321 may be unrelated such that a certain portion of the graph data structure 321 (e.g., corresponding to an entity or event) is unable to be described based on the graph data structure 321 alone. The techniques described herein support understanding the behavior of a process (e.g., Process C of FIG. 5) by checking what files the process accesses (e.g., File 1, File 2), where the process sends the information to, and what other processes the process interacts with. The preprocessing pipeline 210 supports building, from the graph data structure 321 (and one or more subgraphs 326), a textual input with information associated with the process by analyzing the graph data structure 321.

Example aspects of extracting a subgraph 326 using any suitable part of graph data structure 321 in accordance with one or more embodiments of the present disclosure are described herein. The subgraph extraction engine 325 selects a focal node (also referred to herein as a process node) (e.g., Process C of FIG. 5) from among nodes of the graph data structure 321. Through the selection of a focal node, the techniques described herein support maintaining a suitable quantity of subgraphs for analysis by the preprocessing pipeline 210, as process nodes are the first-class citizens that perform actions such as reading and writing data, accessing a network, and the like.

The subgraph extraction engine 325 is capable of applying one or more suitable methods to choose a subgraph 326 based on a selected focal node. The subgraph extraction engine 325 may focus on ancestry and EgoNet (e.g., a subgraph of a directed weight graph), use a weighted random walk, and the like, as described herein.

In a first example, the subgraph extraction engine 325 extracts a neighborhood subgraph of a certain radius (all edges and nodes within the radius from) the selected focal node (e.g., process node, for example, Process C), as well as the ancestry of the process. Process ancestry provides information about the legitimacy of a given process as well as parameters used to execute the process.

In a second example, the subgraph extraction engine 325 extracts a subgraph 326 using a weighted random walk. For example, different node types (e.g., process, file, Network IP/port, user) may have different importance or associated weights (also referred to herein as “weighting factors” or “weight factors”) and different event types (e.g., read, write, spawn). The subgraph extraction engine 325 can apply the weights in a random walk to extract a subgraph 326 having information deemed as important (e.g., according to weight), while keeping the size of the subgraph 326 manageable and dropping events deemed as less important (e.g., according to weight). In one or more embodiments, the subgraph extraction engine 325 may perform a single iteration of the random walk. Additionally, or alternatively, the subgraph extraction engine 325 perform multiple iterations of a random walk to produce multiple subgraphs 326 and sentences around the same process (e.g., Process C) to provide slightly different views.

### Truncation and Sentence Generation Engine 330—Truncation and Sentence Extraction (Order, Form, Special Tokens)

The preprocessing pipeline 210 may apply additional truncation processes as appropriate in ensuring that the text length associated with a chosen subgraph 326 satisfies a threshold input length (also referred to herein as a “maximum input length”) supported by the model 235. In an example, if textualization (by textualization engine 335) is not applied before subgraph extraction (by subgraph extraction engine 325), the preprocessing pipeline 210 supports interactively using textualization, truncation and sentence generation (by truncation and sentence generation engine 330), and tokenization (by tokenization engine 340) to ensure the text length of the subgraph 326 is less than or equal to the threshold input length. In some examples, the preprocessing pipeline 210 determines whether further information can be added to a chosen subgraph 326 by comparing whether the text length associated with a chosen subgraph 326 is less than the threshold input length.

Example aspects of truncation and sentence generation engine 330 for ensuring a projected subgraph 326 fits into the threshold input length of a model 235 are described herein. Given a subgraph 326 produced by subgraph extraction engine 325 with respect to a focal node (e.g., a process, a user, and the like), truncation and sentence generation engine 330 projects the subgraph 326 into smaller subgraphs and feeds the smaller subgraphs as different behavior aspects of the focal node. Non-limiting examples of the behavior aspects include networking behavior of a process (as a focal node), file operation behavior of a process (as a focal node), process interaction behavior of a process (as a focal node), and file owned by a user (as a focal node), and the like.

In one or more embodiments, the subgraph extraction engine 325 may generate each smaller subgraph in accordance with a threshold number of nodes and edges, such that a subgraph 331 (or corresponding tokenized subgraph 341) generated from a subgraph 326 fits the maximum input size of a model 235 which is to receive the subgraph 331 (or corresponding tokenized subgraph 341). In some aspects, the exact length of the input used to check the maximum input size is based on the tokenized sequence, as that is the input to the model 235. Accordingly, for example, the input to the model 235 is a tokenized sequence indicated by tokenized subgraph 341. Text processing 225 is capable of converting a graph into text and then into a sequence of integers. Thus, for example, text processing 225 is capable of changing the name of tokenized subgraph 341 into a sequence of integers (representing the tokenized subgraph 341).

The truncation and sentence generation engine 330 supports multiple options for truncation and sentence generation. Examples of the options are described with reference to an example case of a subgraph 326 provided by subgraph extraction engine 325, in which the subgraph 326 is associated with a process with (i) 4 nodes in its ancestry, (ii) 3 networking nodes, (iii) 5 file nodes, and (iv) 5 process nodes, and truncation and sentence generation engine 330 providing a subgraph 331 by truncating the subgraph 326. In the example case, a model 235 to receive a text input from the preprocessing pipeline 210 is capable of processing a subgraph 331 of at most 8 nodes each time as input, where 8 nodes produce approximately 512 tokens, which is an example of the input length limit. Based on this setting of 512 tokens and 8 nodes, in one or more embodiments, the following examples are implemented by truncation and sentence generation engine 330.

Example 1. Select the focal node (1 node), the full ancestry (4 nodes) of the focal node, and randomly select 3 nodes out of the neighboring nodes of the focal node. If there are less than 3 neighboring nodes, the subgraph 331 could have less than 8 nodes in total.

Example 2. Select the focal node (1 node). If there are more than 7 neighboring nodes, randomly select 7 out of the neighboring nodes of the focal node. If there are less than 7 neighboring nodes, select all neighboring nodes, plus part of the ancestry (e.g., a node from the ancestry) to generate an 8-node subgraph based on the subgraph 326. In some cases, if there are less than 7 neighboring nodes, the resulting subgraph 331 could have less than 8 nodes in total.

Example 3. Select the focal node (1 node), the direct parent node from the ancestry (1 node), and randomly select 6 nodes out of the neighboring nodes. If there are less than 6 neighboring nodes, the resulting subgraph 331 could have less than 8 nodes in total.

Example 4. Select the focal node (1 node), the direct parent node from the ancestry (1 node), and select all nodes of a single type (e.g., network nodes, process nodes, or the like) from among the neighboring nodes. In an example, the total number of nodes (e.g., 5 nodes) of the resulting subgraph 331 could be less than 8 nodes.

Example 5. Select the focal node (1 node), the direct parent node from the ancestry (1 node), and randomly select a neighboring node from each type of neighboring node (e.g., select 1 network node, 1 file node, and 1 process node). In an example, the total number of nodes (e.g., 5 nodes) of the resulting subgraph 331 could be less than 8 nodes.

Example 6. Select the focal node (1 node), and randomly select subgraphs 326 associated with the focal node (e.g., originating from the focal node, ending at the focal node, including the focal node) until a selected subgraph 326 meets the threshold input length supported by the model 235.

With reference to Examples 1 through 6 described herein, Examples 1 and 2 yield/project a single subgraph 331, and Examples 3, 4, 5 support yielding/projecting multiple subgraphs 331 corresponding to different behaviors. The techniques described herein support implementations in which any of Examples 1 through 6 is applied multiple times. For example, the techniques described herein may include removing a portion of a considered subgraph 326 and repeating subgraph extraction (e.g., using the techniques of any of Examples 1 through 6) with the remaining portion of the subgraph 326. The subgraph extraction techniques may include updating the parameters for subgraph extraction according to the threshold input length associated with a model 235 or dynamically adjusting the parameters based on the characteristics of the telemetry data, the input subgraph 326 or the output subgraph 331 as well as the types of events in the subgraphs. The tokenization engine 340 processes each subgraph 331 output by truncation and sentence generation engine 330 before feeding a tokenized subgraph 341 (e.g., a tokenized representation of the subgraph 331) to the models 235.

As described herein, the features provided by subgraph extraction engine 325 and truncation and sentence generation engine 330 both help to resolve the threshold input length associated with models 235. Additional goals supported by subgraph extraction engine 325 include providing models 235 with an indication of on what to focus (e.g., a focal node and neighborhood subgraph around the focal node), and additional goals supported by truncation and sentence generation engine 330 include generating different aspects of behaviors for the models 235 to learn.

### Tokenization Engine 340—Tokenization

The preprocessing pipeline 210 supports tokenization (by tokenization engine 340) as preprocessing for textual input. In some examples, the preprocessing pipeline 210 may implement tokenization at any appropriate point after textualization or together with textualization. The tokenization provided by tokenization engine 340 supports text modality as input. Tokenization can be applied by tokenization engine 340 to convert textualized data, i.e., a sequence of words, generated by the textualization engine 335 into a sequence of tokens by using a tokenization method such as Byte-Pair Encoding (BPE), WordPiece or SentencePiece.

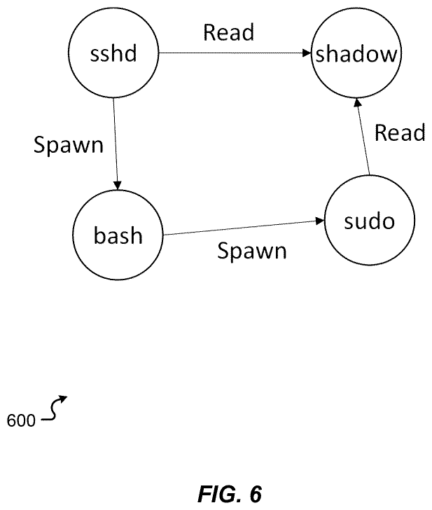

FIG. 6 illustrates an example subgraph 600 (also referred to herein as a “subgraph data structure”) provided by preprocessing pipeline 210 in accordance with one or more embodiments of the present disclosure. The subgraph 600 includes aspects of a subgraph 326 extracted by subgraph extraction engine 325, a subgraph 331 provided by truncation and sentence generation engine 330, or a corresponding tokenized subgraph 341 output by tokenization engine 340 as described herein. Referring to FIG. 6, the subgraph 600 may include enrichment information (e.g., domain knowledge) as provided by knowledge enrichment engine 315 as described herein. The subgraph 600 may include indications of event type (e.g., read, spawn, and the like) and object names (e.g., sshd, shadow, bash, sudo, and the like).

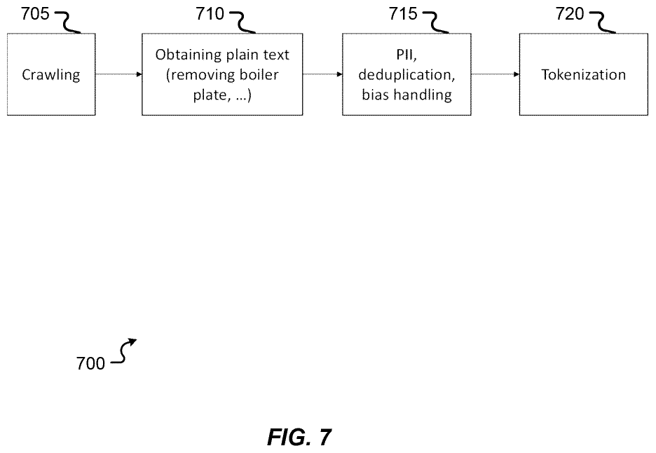

FIG. 7 is an example flow diagram 700 that illustrates an example of some other pipelines for general natural language large language models. In some cases, natural language documents have coherent topics except for the boilerplate, advertisements, and the like. Other pipelines, for example, as illustrated at FIG. 7, may include crawling at 705, obtaining plain text at 710, personally identifiable information (PII) detection, deduplication, and bias handling at 715, and tokenization at 720, but are not suitable for or capable of processing telemetry data. For example, telemetry data can include multiple behaviors and topics scattered and mixed over a period of time, such that the behaviors and topics are incoherent to the model relying on such existing pipelines.

The example aspects described herein support preparing telemetry data for models described herein (e.g., machine learning models, foundation models, statistical models, large language models, deep learning models, and the like) which is lacking in other approaches for processing telemetry data. The techniques described herein support processing raw telemetry data associated with a system and providing, in a format compatible with a model, corresponding textual data representative of behaviors of the system. The techniques described herein include considering sentence format or graph construction to identify events relevant to one another within the telemetry data. The techniques described herein include truncation and domain specific processing in accordance with a threshold input length of a model (e.g., a machine learning model, a statistical model, a foundation model, a large language model, or the like), which is lacking in other approaches for processing telemetry data.

The textual representation provided by the preprocessing pipeline as described herein includes behavioral information of entities in a system, which when provided to a model 235 (e.g., a machine learning model, a statistical model, a foundation model, a large language model, a non-FM machine learning model) with respect to cybersecurity application, supports improved training of and detection by the models. For example, some cybersecurity models are based on one of two main approaches: 1. task-specific classification (e.g., often with manually crafted features) and 2. large language models ingesting cybersecurity log data with little pre-processing.

A cybersecurity model allows for fine-tuning models to be trained across a large number of independent but related tasks with significantly few labeled training samples. Providing textual data (e.g., tokenized textual data 255) as generated by a preprocessing pipeline as described herein to a cybersecurity model enables increased accuracy, increased processing efficiency, and reduced processing overhead with respect to threat management, threat investigation, threat hunting, response, and the like (e.g., threat detection, threat classification, behavioral similarity search, behavioral classification, threat prioritization, attack evolution prediction, security posture management).

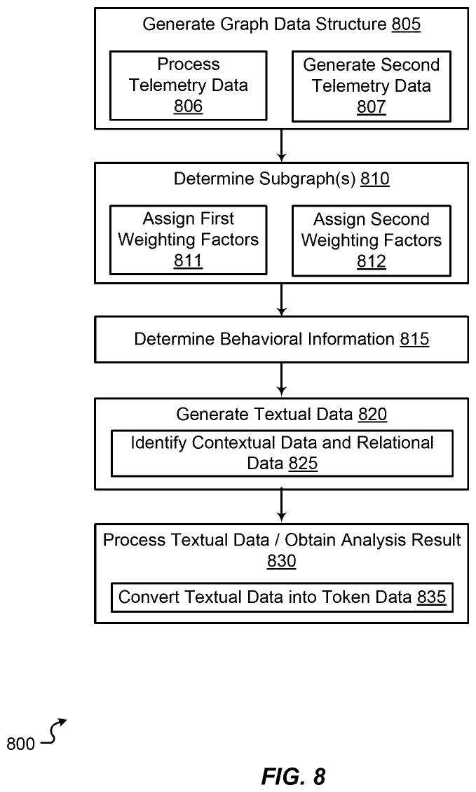

FIG. 8 illustrates an example flowchart of a method 800 in accordance with one or more embodiments of the present disclosure.

At 805, the method 800 includes generating a graph data structure based on processing telemetry data (at 806) associated with at least one computer system, where the graph data structure is representative of a set of events and a set of entities associated with the at least one computer system.

In one or more embodiments, the method 800 includes generating second telemetry data (at 807) based on the telemetry data, where generating the second telemetry data includes at least one of: replacing one or more first data portions of the telemetry data with first domain knowledge corresponding to the one or more first data portions; and appending, to the telemetry data, second domain knowledge corresponding to one or more second data portions of the telemetry data. In one or more embodiments, generating the graph data structure is based on processing the second telemetry data. At 810, the method 800 includes determining one or more subgraphs.

In one or more embodiments, the method 800 includes determining the one or more subgraphs based on at least one of: a process ancestry associated with a node (e.g., a focal node) included in the graph data structure; and event data associated with the node and the process ancestry. In one or more embodiments, the method 800 includes determining the one or more subgraphs based on a node included in the graph data structure, where the node corresponds to a process, a data file, a user, or network traffic of the at least one computer system. In one or more embodiments, the method 800 includes determining the one or more subgraphs based on a threshold radius of an area originating from a node included in the graph data structure. In one or more embodiments, the method 800 includes determining the one or more subgraphs based on an anomaly score associated with one or more of: the at least one computer system, an entity associated with the at least one computer system, and an event associated with the at least one computer system. In one or more embodiments, the method 800 includes determining the one or more subgraphs based on a weighted random walk of at least a portion of the graph data structure, where the weighted random walk originates at a node included in the graph data structure.

In one or more embodiments, the method 800 includes assigning (at 811) first weighting factors to nodes included in the graph data structure based on node type; assigning (at 812) second weighting factors to edges included in the graph data structure based on edge type; and determining the one or more subgraphs by truncating a selected subgraph included in the graph data structure, based on at least one of the first weighting factors and the second weighting factors.

At 815, the method 800 includes determining behavioral information associated with the at least one computer system based on the one or more subgraphs.

At 820, the method 800 includes generating a textual representation of the behavioral information (e.g., sentences representing the behavioral information, textual representation for behavioral information) associated with at least one entity of the set of entities and at least one event of the set of events, based on the one or more subgraphs included in the graph data structure. In one or more embodiments, the textual representation is of natural language format compatible with one or more models; and a length of the textual representation satisfies a threshold text length associated with the one or more models. In one or more embodiments, the one or more models may include at least one of machine learning model, a statistical model, a foundation model, a and a deep learning model.

In one or more embodiments, generating the textual representation comprises connecting textual representations of nodes and edges comprised in the one or more subgraphs.

In one or more embodiments, the method 800 includes identifying (at 825), based on the one or more subgraphs: contextual data associated with one or more subsets of events included in the set of events; and relational data corresponding to processes associated with the one or more subsets of events, where generating the textual representation is based on the contextual data and the relational data.

At 830, the method 800 includes obtaining an analysis result associated with the at least one computer system based on processing the textual representation by the one or more models. In one or more embodiments, the one or more models includes a trained large language model (LLM) or a trained foundation model (FM). In one or more embodiments, the analysis result includes an indication of: anomalous activity associated with the at least one computer system; and at least one of an entity and an event associated with the anomalous activity.

At 835, the method 800 includes converting the textual representation into token data, where obtaining the analysis result is based on the one or more models processing the token data. In one or more embodiments, converting the textual representation into the token data includes at least one of: generating the token data from the textual representation using one or more templates and a set of template fill rules; and generating the token data from the textual representation using a set of rules associated with a context-free grammar.

In one or more embodiments, processing the textual representation includes performing one or more analysis operations associated with generating the analysis result, where the one or more analysis operations include at least one of: assigning classification information to portions of the textual representation; and clustering the portions of the textual representation based on the classification information.

In one or more embodiments, the method 800 includes generating prediction information associated with the analysis result based on processing the textual representation, where the prediction information includes an indication of a maliciousness of the at least one event, an owner or user associated with the at least one event, a process that executed the at least one event, a behavior of the at least one event, and a tactics, techniques, and procedures (TTP) classification of the at least one event. In some aspects, TTP may represent an attacker's goals and methods.

In one or more embodiments, the method 800 includes training the one or more models in association with a plurality of tasks based on training data, where the training data includes reference telemetry data and reference textual representations associated with the reference telemetry data. In one or more embodiments, obtaining the analysis result is based on the training of the one or more models, and the analysis result is associated with at least one task of the plurality of tasks.

In one or more embodiments, the plurality of tasks are independent of one another and are interrelated.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
generating a graph data structure based on processing telemetry data associated with at least one computer system, wherein the graph data structure is representative of a set of events and a set of entities associated with the at least one computer system;
generating a textual representation of behavioral information associated with at least one entity of the set of entities and at least one event of the set of events, based on one or more subgraphs comprised in the graph data structure; and
obtaining an analysis result associated with the at least one computer system based on processing the textual representation by one or more models, wherein the one or more models comprise at least one of a machine learning model, a statistical model, and a foundation model.

2. The computer-implemented method of claim 1, further comprising:
determining the one or more subgraphs based on at least one of:
a process ancestry associated with a node comprised in the graph data structure; and
event data associated with the node and the process ancestry; and
determining the behavioral information associated with the at least one computer system based on the one or more subgraphs.

3. The computer-implemented method of claim 1, further comprising:
determining the one or more subgraphs based on a node comprised in the graph data structure, wherein the node corresponds to a process, a data file, a user, or network traffic of the at least one computer system.

4. The computer-implemented method of claim 1, further comprising:
determining the one or more subgraphs based on a threshold radius of an area originating from a node comprised in the graph data structure.

5. The computer-implemented method of claim 1, further comprising:
determining the one or more subgraphs based on at least one of:
an anomaly score associated with one or more of: the at least one computer system, an entity associated with the at least one computer system, and an event associated with the at least one computer system; and
a weighted random walk of at least a portion of the graph data structure, wherein the weighted random walk originates at a node comprised in the graph data structure.

6. The computer-implemented method of claim 1, further comprising:
wherein generating the textual representation comprises connecting textual representations of nodes and edges comprised in the one or more subgraphs.

7. The computer-implemented method of claim 1, wherein:
the textual representation is of natural language format compatible with the one or more models; and
a length of the textual representation satisfies a threshold text length associated with the one or more models.

8. The computer-implemented method of claim 1, further comprising:
assigning first weighting factors to nodes comprised in the graph data structure based on node type;
assigning second weighting factors to edges comprised in the graph data structure based on edge type; and
determining the one or more subgraphs by truncating a selected subgraph comprised in the graph data structure, based on at least one of the first weighting factors and the second weighting factors.

9. The computer-implemented method of claim 1, further comprising:
generating second telemetry data based on the telemetry data, wherein generating the second telemetry data comprises at least one of:
replacing one or more first data portions of the telemetry data with first domain knowledge corresponding to the one or more first data portions; and
appending, to the telemetry data, second domain knowledge corresponding to one or more second data portions of the telemetry data,
wherein generating the graph data structure is based on processing the second telemetry data.

10. The computer-implemented method of claim 1, further comprising:
identifying, based on the one or more subgraphs:
contextual data associated with one or more subsets of events comprised in the set of events; and
relational data corresponding to processes associated with the one or more subsets of events,
wherein generating the textual representation is based on the contextual data and the relational data.

11. The computer-implemented method of claim 1, wherein the analysis result comprises an indication of:
anomalous activity associated with the at least one computer system; and
at least one of an entity and an event associated with the anomalous activity.

12. The computer-implemented method of claim 1, further comprising:
converting the textual representation into token data,
wherein obtaining the analysis result is based on the one or more models processing the token data.

13. The computer-implemented method of claim 12, wherein converting the textual representation into the token data comprises at least one of:
generating the token data from the textual representation using one or more templates and a set of template fill rules; and
generating the token data from the textual representation using a set of rules associated with a context-free grammar.

14. The computer-implemented method of claim 1, wherein the one or more models comprise a trained machine learning model, a trained statistical model, a trained large language model, or a trained foundation model.

15. The computer-implemented method of claim 1, wherein processing the textual representation comprises performing one or more analysis operations associated with generating the analysis result, wherein the one or more analysis operations comprise at least one of:
assigning classification information to portions of the textual representation; and
clustering the portions of the textual representation based on the classification information.

16. The computer-implemented method of claim 1, further comprising:
generating prediction information associated with the analysis result based on processing the textual representation, wherein the prediction information comprises an indication of a maliciousness of the at least one event, an owner or user associated with the at least one event, a process that executed the at least one event, a behavior of the at least one event, and a Tactics, Techniques, and Procedures (TTP) classification of the at least one event.

17. The computer-implemented method of claim 1, further comprising:
training the one or more models in association with a plurality of tasks based on training data, wherein the training data comprises reference telemetry data and reference textual representations associated with the reference telemetry data,
wherein obtaining the analysis result is based on the training of the one or more models, and the analysis result is associated with at least one task of the plurality of tasks.

18. The computer-implemented method of claim 17, wherein:
the plurality of tasks are independent of one another and are interrelated.

2. A computing system having a memory having computer readable instructions and one or more processors for executing the computer readable instructions, the computer readable instructions controlling the one or more processors to perform operations comprising:
generating a graph data structure based on processing telemetry data associated with at least one computer system, wherein the graph data structure is representative of a set of events and a set of entities associated with the at least one computer system;
generating a textual representation of behavioral information associated with at least one entity of the set of entities and at least one event of the set of events, based on one or more subgraphs comprised in the graph data structure; and
obtaining an analysis result associated with the at least one computer system based on processing the textual representation by one or more models, wherein the one or more models comprise at least one of a machine learning model, a statistical model, and a foundation model.

3. A computer program product comprising a computer readable storage medium having program instructions embodied therewith, the program instructions executable by a processor to cause the processor to perform operations comprising:
generating a graph data structure based on processing telemetry data associated with at least one computer system, wherein the graph data structure is representative of a set of events and a set of entities associated with the at least one computer system;
generating a textual representation of behavioral information associated with at least one entity of the set of entities and at least one event of the set of events, based on one or more subgraphs comprised in the graph data structure; and
obtaining an analysis result associated with the at least one computer system based on processing the textual representation by one or more models, wherein the one or more models comprise at least one of a machine learning model, a statistical model, and a foundation model.
